(19) United States
(12) Patent Application Publication
(10) Pub. No.: US 2015/0253563 A1
(43) Pub. Date: Sep. 10, 2015

(54) Mounting System Latch and Methods Thereof

(71) Applicant: Joseph A. DiCarlo, Chester, NH (US)

(72) Inventor: Joseph A. DiCarlo, Chester, NH (US)

(21) Appl. No.: 14/639,470

(22) Filed: Mar. 5, 2015

Related U.S. Application Data
(60) Provisional application No. 61/949,610, filed on Mar. 7, 2014.

(51) Int. Cl. G02B 23/16

(52) U.S. Cl. CPC G02B 23/16

(57) ABSTRACT

A mounting system latch apparatus and related methods are provided. The apparatus includes a mounting shoe receiving structure. A locking device is movably mounted proximate to the mounting shoe receiving structure, wherein the locking device is movable in at least a first direction through an upper plane of the mounting shoe receiving structure. A latch handle is movably mounted proximate to the locking device, wherein an engaging structure of the latch handle contacts the locking device, and wherein the latch handle is movable in at least a second direction to engage movement of the locking device in the first direction, wherein the second direction is substantially perpendicular to the first direction.

### CROSS REFERENCE TO RELATED APPLICATION

This application claims benefit of U.S. Provisional Application Ser. No. 61/949,610 entitled, “Mounting System Latch and Methods Thereof” filed Mar. 7, 2014, the entire disclosure of which is incorporated herein by reference.

### FIELD OF THE DISCLOSURE

The present disclosure is generally related to mounting apparatuses and more particularly is related to a mounting system latch and methods thereof and related methods.

### BACKGROUND OF THE DISCLOSURE

Optical devices are commonly used in various environments to enhance the capabilities of the user's vision. In military environments, various optical devices are used to give a soldier enhanced visibility in harsh conditions. For example, head-mounted display devices may be used within the military, in combination with other optical devices, to enhance a soldier's visibility in various conditions. For example, a head-mounted display device may be used with a camera whereby the head-mounted display device visually displays the image captured by the camera. These mounted displays are affixed to combat helmets primarily, but may also be affixed to weapons, or other structures that a soldier uses, and during a field operation. It may be common for a soldier to move the mounted display between different positions, i.e., between the left and right eyes, or between various mounting structures.

There are many difficulties that a soldier may experience when attempting to mount, remount, or remove a mounted display device from the mounting structure. Many conventional mounting devices do not allow for quick mounting or quick dismounting of the mounted display and many of these conventional mounting devices are prone to inadvertent dismounting of the mounted display, such as when a soldier accidently contacts the device. Additionally, it can often be difficult for a soldier to position the mounted display device to their liking. Conventional mounting systems are difficult to remove from the mounted display and often provide few options for positioning the mounted display at a desired location.

Thus, a heretofore unaddressed need exists in the industry to address the aforementioned deficiencies and inadequacies.

### SUMMARY OF THE DISCLOSURE

Embodiments of the present disclosure provide a mounting system latch and related methods. Briefly described, in architecture, one embodiment of the system, among others, can be implemented as follows. The mounting system latch includes a mounting shoe receiving structure. A locking device is movably mounted proximate to the mounting shoe receiving structure, wherein the locking device is movable in at least a first direction through an upper plane of the mounting shoe receiving structure. A latch handle is movably mounted proximate to the locking device, wherein an engaging structure of the latch handle contacts at least a portion of the locking device, and wherein the latch handle is movable in at least a second direction to engage movement of the locking device in the first direction, wherein the second direction is substantially perpendicular to the first direction.

The present disclosure can also be viewed as providing a dual optical device mounting system latch apparatus. Briefly described, in architecture, one embodiment of the apparatus, among others, can be implemented as follows. The dual optical device mounting system latch has a housing structure which comprises a mounting shoe receiving structure sized to receive a mounting shoe of a first optical device therein, a locking device pivotally mounted to the housing structure, wherein the locking device is movable in at least a first direction through an upper plane of the mounting shoe receiving structure, and a latch handle pivotally mounted to the housing structure, wherein an engaging structure of the latch handle is positioned in sliding contact with an engaging face of the locking device, and wherein the latch handle is movable in at least a second direction to control movement of the locking device in the first direction, wherein the second direction is substantially perpendicular to the first direction. An optical device retaining structure is connected to the housing structure, wherein the optical device retaining structure is sized to retain a second optical device therein.

The present disclosure can also be viewed as providing a method of using a dual optical device mounting system latch. In this regard, one embodiment of such a method, among others, can be broadly summarized by the following steps: connecting a first optical device having a mounting shoe to a mounting shoe receiving structure; movably mounting a locking device proximate to the mounting shoe receiving structure, wherein the locking device is movable in at least a first direction through an upper plane of the mounting shoe receiving structure; and movably mounting a latch handle proximate to the locking device, wherein an engaging structure of the latch handle contacts at least a portion of the locking device, and wherein the latch handle is movable in at least a second direction to engage movement of the locking device in the first direction, wherein the second direction is substantially perpendicular to the first direction.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view illustration of a mounting system latch apparatus, in accordance with a first exemplary embodiment of the present disclosure.

FIG. 2A is an isometric view illustration of the latch handle of the mounting system latch apparatus of FIG. 1, in accordance with the first exemplary embodiment of the present disclosure.

FIG. 2B is an isometric view illustration of the locking device of the mounting system latch apparatus of FIG. 1, in accordance with the first exemplary embodiment of the present disclosure.

FIG. 2C is an isometric view illustration of a housing structure of the mounting system latch apparatus of FIG. 1, in accordance with the first exemplary embodiment of the present disclosure.

FIGS. 3A-3B are exploded view illustrations of the mounting system latch apparatus of FIG. 1, in accordance with the first exemplary embodiment of the present disclosure.

FIGS. 4A-4B are isometric view illustrations of the latch handle and the locking device of the mounting system latch apparatus of FIG. 1, in accordance with the first exemplary embodiment of the present disclosure.

FIG. 5 is a cross-sectional isometric view illustration of the mounting system latch apparatus of FIG. 1, in accordance with the first exemplary embodiment of the present disclosure.

FIGS. 6A-6B are isometric view illustrations of the mounting system latch apparatus of FIG. 1 with the locking device in engaged and disengaged positions, in accordance with the first exemplary embodiment of the present disclosure.

FIG. 7 is a top partial exploded view illustration of the apparatus of FIG. 1 with a mounting shoe, in accordance with the first exemplary embodiment of the present disclosure.

FIG. 8 is a bottom partial exploded view illustration of the apparatus of FIG. 1 with a mounting shoe, in accordance with the first exemplary embodiment of the present disclosure.

FIGS. 9-10 are isometric illustrations of the mounting system latch apparatus used with an optical device retaining structure, in accordance with the first exemplary embodiment of the present disclosure.

FIGS. 11A-11C are two isometric illustrations and one cross-sectional isometric illustration of the mounting system latch apparatus used with an optical device retaining structure, in accordance with the first exemplary embodiment of the present disclosure.

FIGS. 12-13 are isometric illustrations of the mounting system latch apparatus used with two or more optical devices, in accordance with the first exemplary embodiment of the present disclosure.

FIG. 14 is a flowchart illustrating a method of using a dual optical device mounting system latch apparatus, in accordance with the first exemplary embodiment of the present disclosure.

### DETAILED DESCRIPTION

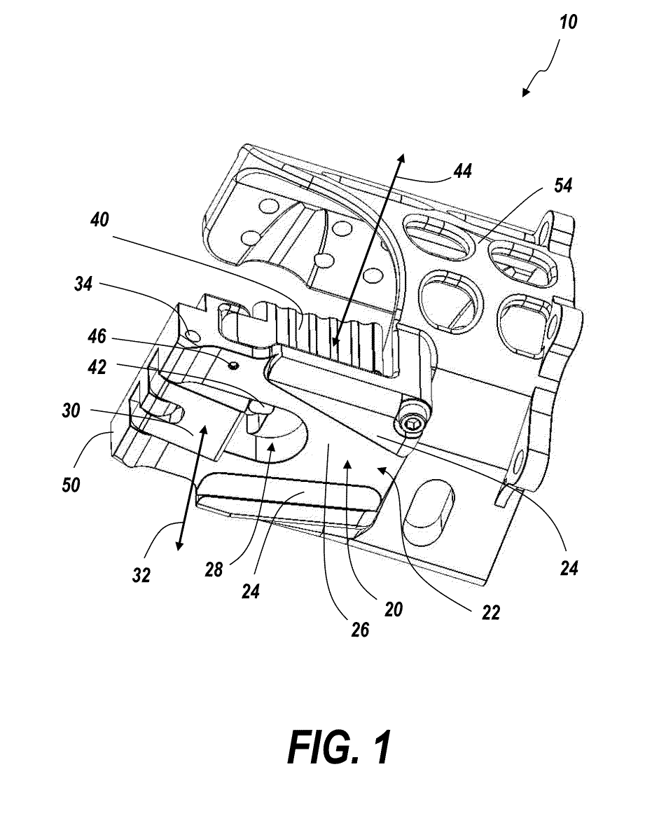

FIG. 1 is an isometric view illustration of a mounting system latch apparatus 10, in accordance with a first exemplary embodiment of the present disclosure. The mounting system latch apparatus 10, which may be referred to herein as ‘apparatus 10’ includes a mounting shoe receiving structure 20. A locking device 30 is movably mounted proximate to the mounting shoe receiving structure 20, wherein the locking device 30 is movable in at least a first direction 32 through an upper plane 22 of the mounting shoe receiving structure 20. A latch handle 40 is movably mounted proximate to the locking device 30, wherein an engaging structure 42 of the latch handle 40 contacts the locking device 30, and wherein the latch handle 40 is movable in at least a second direction 44 to engage movement of the locking device 30 in the first direction 32, wherein the second direction 44 is substantially perpendicular to the first direction 32.

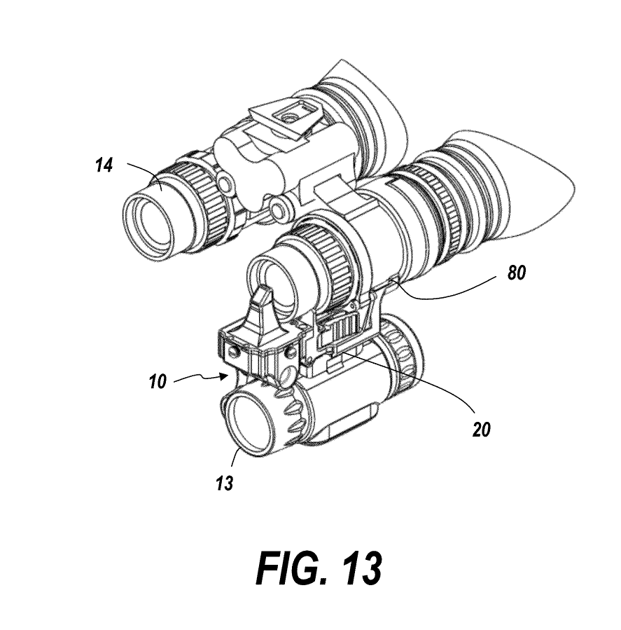

The apparatus 10 may be used for mounting an optical device, as shown in FIGS. 12-13, to a mounting structure, such as a helmet, a weapon, or another tool to which the optical device is mounted. In particular, the apparatus 10 as illustrated in FIG. 1 may be used for mounting one optical device to another optical device to create a fused image. For example, a thermal imaging device may be mounted with the apparatus 10 shown in FIG. 1 to a night vision imaging device, thereby allowing for a fused image of both thermal and night vision capabilities. Within the industry, this type of combined image may be referred to as ‘fusion imaging’, among other names. The apparatus 10 may be used with this type of mounting use or any other type of mounting use, such as non-fusion imaging, all of which are considered within the scope of the present disclosure.

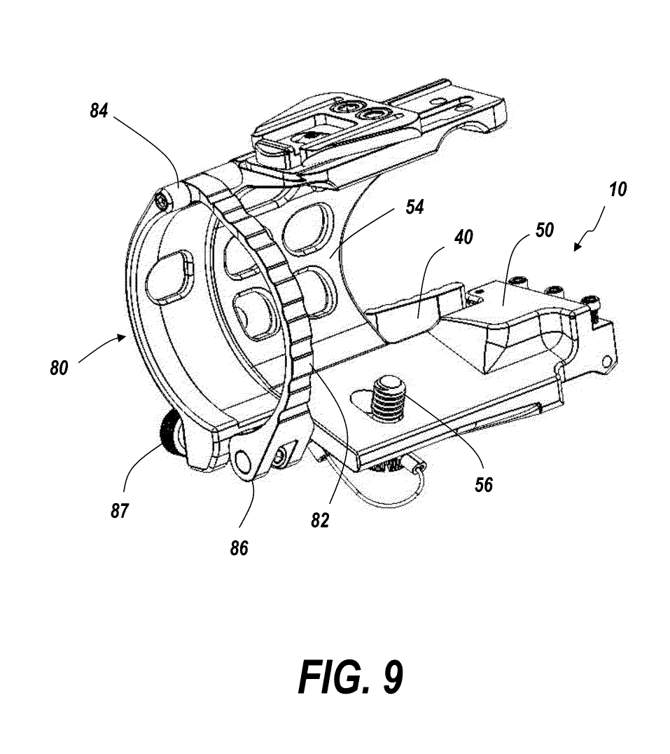

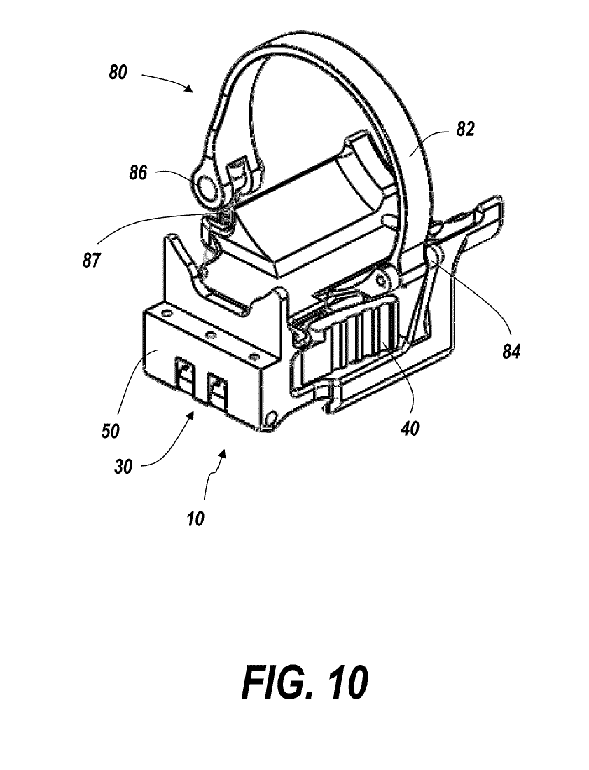

The mounting shoe receiving structure 20 may be an inverse wedge structure with angled sides that is used to receive a mounting shoe (shown in FIGS. 7-8), which is a wedge structure having inwardly angled, tapered sides and an engagement cavity in the middle, as is well-known within the art. The mounting shoe receiving structure 20 may be conventionally used on many mounting devices and the mounting shoe is commonly mounted on many optical devices, to mount optical devices to mounting structures. While the precise structure of the mounting shoe receiving structure 20 may vary, it generally includes at least two sidewalls 24 which are inwardly angled to one another and are oriented in a tapered fashion towards one another. The sidewalls 24 may be connected to a mounting surface 26 of the mounting shoe receiving structure 20. The mounting surface 26 may be a substantially planar surface which the mounting shoe contacts, or substantially contacts, when the mounting shoe is inserted into the mounting shoe receiving structure 20. In the orientation of the apparatus 10 of FIG. 1, the mounting surface 26 may be characterized as a ceiling of the mounting shoe receiving structure 20. As is also shown in FIG. 1, the mounting surface 26 may include a hole 28, or other features, which the locking device 30 can be positioned or moved within.

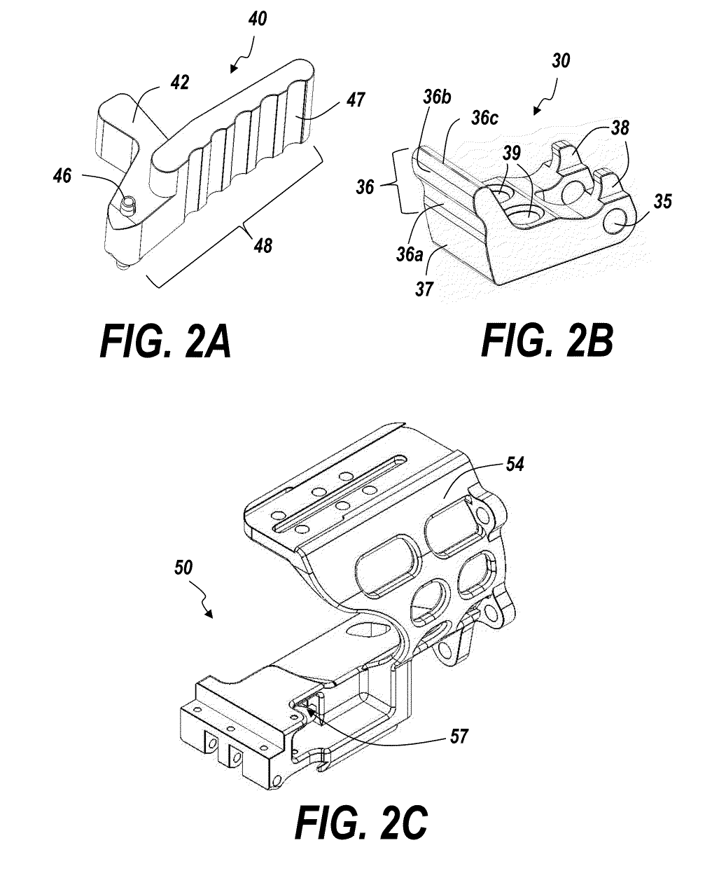

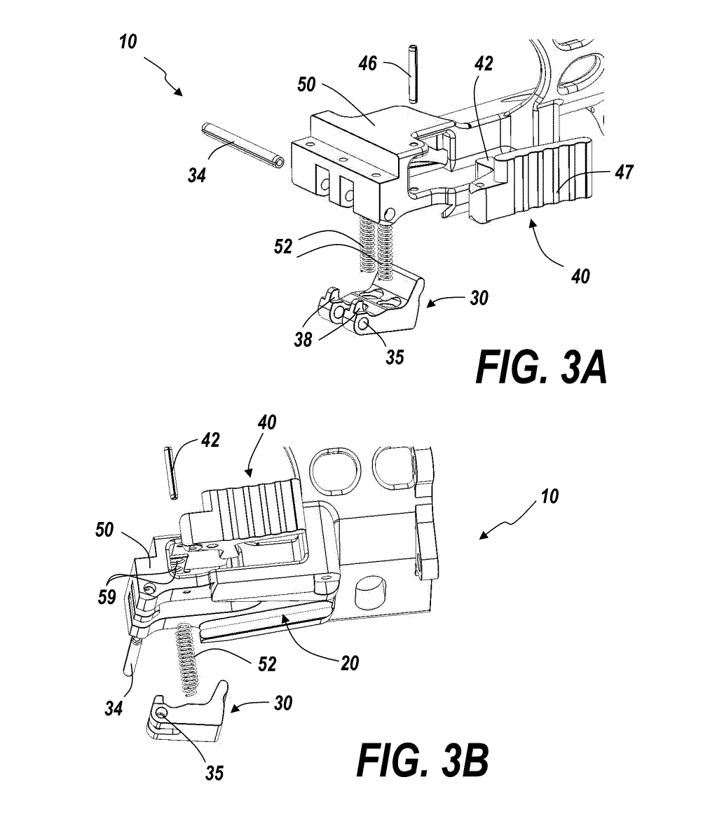

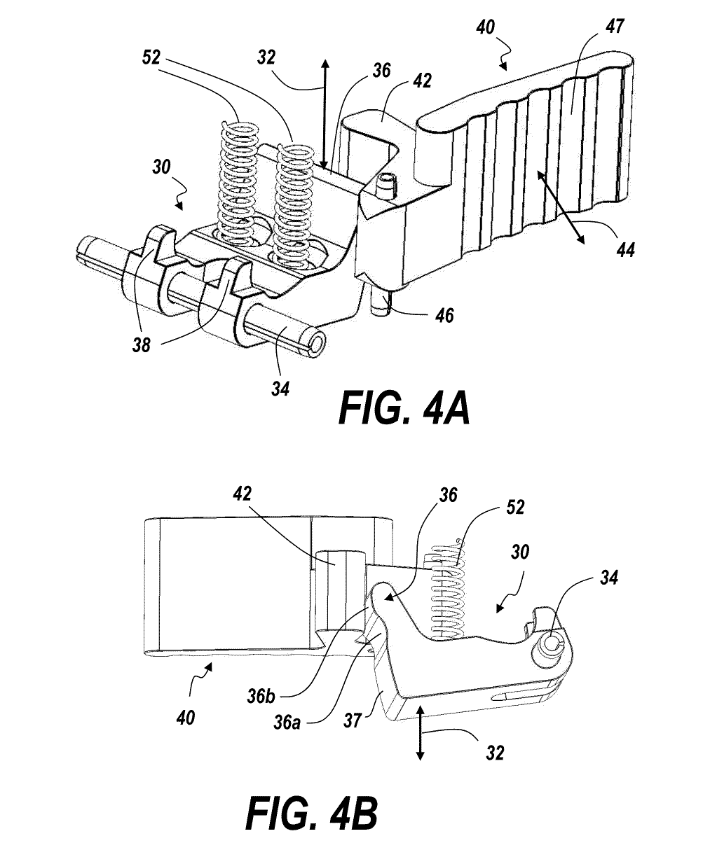

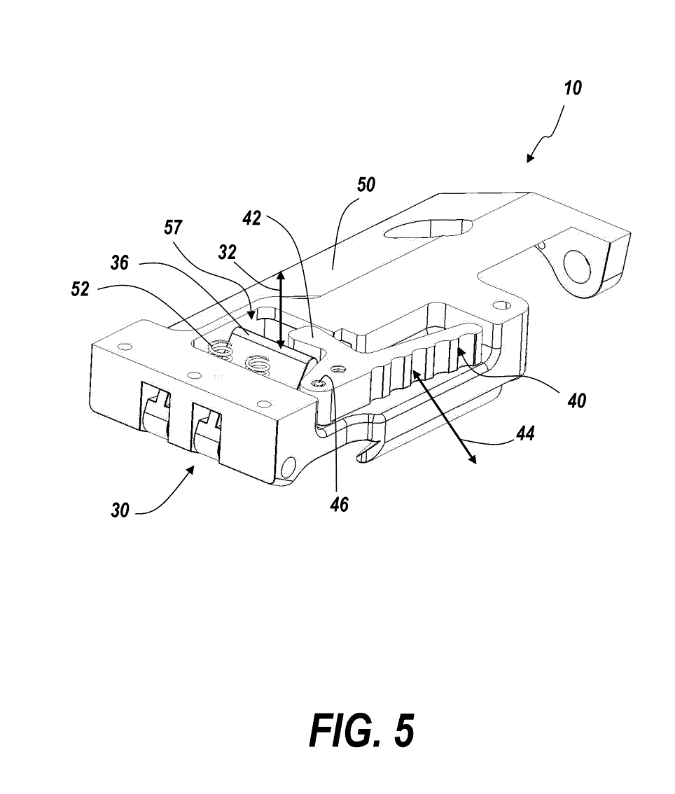

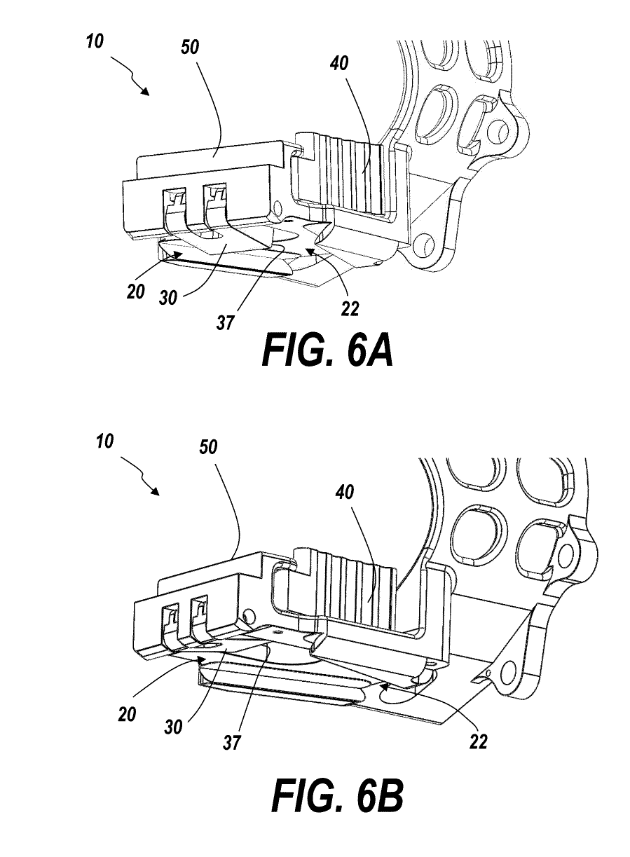

FIGS. 2A-2C illustrate individual components of the apparatus 10 for clarity in explanation. Specifically, FIG. 2A is an isometric view illustration of the latch handle 40 of the mounting system latch apparatus 10 of FIG. 1, in accordance with the first exemplary embodiment of the present disclosure. FIG. 2B is an isometric view illustration of the locking device 30 of the mounting system latch apparatus 10 of FIG. 1, in accordance with the first exemplary embodiment of the present disclosure. FIG. 2C is an isometric view illustration of a housing structure 50 of the mounting system latch apparatus 10 of FIG. 1, in accordance with the first exemplary embodiment of the present disclosure. FIGS. 3A-3B are exploded view illustrations of the mounting system latch apparatus 10 of FIG. 1, in accordance with the first exemplary embodiment of the present disclosure. FIGS. 3A-3B are exploded view illustrations of the mounting system latch apparatus 10 of FIG. 1, in accordance with the first exemplary embodiment of the present disclosure. FIGS. 4A-4B are isometric view illustrations of the latch handle 40 and the locking device 30 of the mounting system latch apparatus 10 of FIG. 1, in accordance with the first exemplary embodiment of the present disclosure.

With reference to FIGS. 1-4B, the locking device 30 may be movably mounted with an axle 34 or on a pivot point to a housing structure 50 or other structure that the apparatus 10 is formed within or located proximate to. For example, as is shown in FIGS. 1 and 2C, the housing structure 50 may include cage structure 54 which can be used to hold an optical device. The housing structure 50 may have a variety of designs and components, including a cavity space 57, identified in FIG. 2C, in which a portion of the locking device 30 and the latch handle 40 may be positioned in, as shown in FIG. 1. The cavity space 57 may connect to the hole 28 which the locking device 30 is movable within between engaged and disengaged positions.

The locking device 30, shown in detail in FIG. 2B, may have a variety of shapes, configurations, and sizes. For example, the locking device 30 may include a locking face 37 for making contact with the mounting shoe to retain it within the mounting shoe receiving structure 20, and an engaging face 36 for engaging contact with the engaging structure 42 of the latch handle 40. The engaging face 36 and locking face 37 may be positioned distal from, or a spaced distance away from, the pivot point 35. An axle 34 or similar structure may be used to allow pivoting movement about the pivot point 35.

The engaging face 36 may include a substantially planar surface having a groove 36a formed therein. The engaging face 36 may be further defined as having a contact surface 36b positioned thereon, wherein the contact surface 36b is positioned between the groove 36a and a terminating end 36c of the engaging face 36. The locking face 37 may be positioned below the engaging face 36 and may be positioned substantially parallel to the contact surface 36b of the engaging face 36 with the groove 36a positioned therebetween. The groove 36a of the engaging face 36 of the locking device 30 may also be considered a blind cavity or inward impression. The exact shape and size of the engaging face 36 of the locking device 30 may enhance the efficient engagement between the locking device 30 and the latch handle 40. For example, as is shown, the engaging face 36 of the locking device 30 may have a substantially planar shape with a rounded, blind cavity therein. In other examples, the engaging face 36 may include two planar structures which are not co-planar, with an angled portion therebetween. All various designs are considered within the scope of the present disclosure.

Shown in detail in FIG. 2A, the latch handle 40 may be used to control movement of the locking device 30 in the first direction. The latch handle 40 may have an elongated body 48 having a pivot point at a first end, e.g., around axle 46, and a handle portion 47 positions extending to an opposing end. An engaging structure 42 may be positioned extending laterally from the elongated body 48. The latch handle 40 may have a variety of other shapes, configurations, and sizes, all of which are considered within the scope of the present disclosure. As is shown in FIGS. 3A-3B, the apparatus 10 may utilize springs 52 or other biasing elements to provide a biasing force on the locking device 30. The springs 52 may be positioned between the housing structure 50 and the locking device 30, such as by connecting with positioning cavities 39 of the locking device 30 and positioning cavities 59 of the housing structure 50.

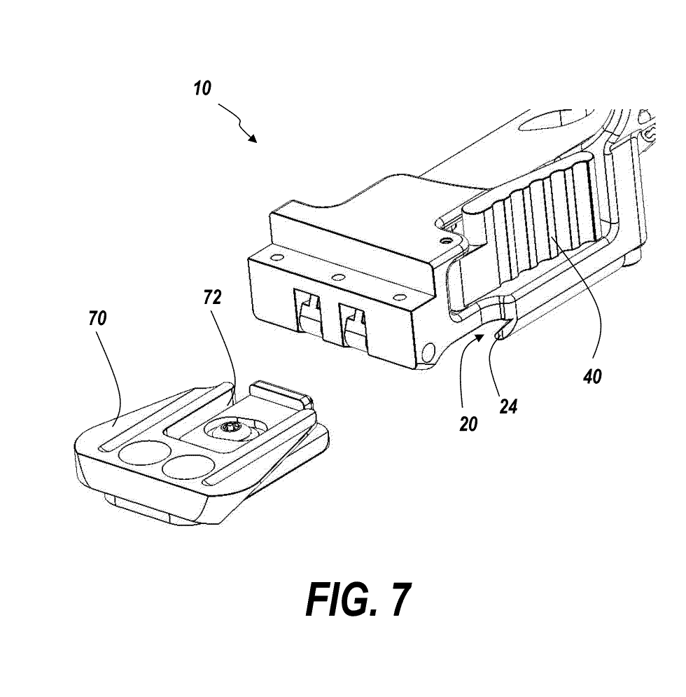

FIG. 5 is a cross-sectional isometric view illustration of the mounting system latch apparatus 10 of FIG. 1, in accordance with the first exemplary embodiment of the present disclosure. Referring to FIGS. 1-5, the relationship and positioning of the locking device 30 to the latch handle 40 is described. The latch handle 40 may be positioned on an exposed side of the housing structure 50 with the engaging structure 42 positioned extending into the housing structure 50 into the cavity space 57 thereof. The locking device 30 is positioned on an underside of the housing structure 50 and engaging face 36 positioned at least partially within the cavity space 57 of the housing structure 50. The engaging structure 42 of the latch handle 40 may make contact with an engaging face 36 of the locking device 30. The locking device 30 may be movable in at least the first direction 32 through an upper plane 22 of the mounting shoe receiving structure 20. The specific position of the upper plane 22 may vary and may not necessarily coincide with the immediate upper surface of the mounting shoe receiving structure 20. Rather, the upper plane 22 may be characterized as a plane of the mounting shoe receiving structure 20 which is positioned at or near an upper surface of a mounting shoe positioned within the mounting shoe receiving structure 20 which the locking device 30 must pass through in order to successfully lock into a locking cavity of a mounting shoe. The first direction 32, as identified by the arrow, is substantially perpendicular to the upper plane 22 of the mounting shoe receiving structure 20.

The latch handle 40 may be movably mounted with the axle 46, or on a similar pivot point, to the housing structure 50 or to another structure that the apparatus 10 is formed within or located proximate to. The latch handle 40 is movable in at least the second direction 44 which is a direction that is substantially perpendicular to the first direction 32. For example, when the latch handle 40, or the handle portion 47 of the latch handle 40, is moved sideways, i.e., into the internal cavity 57 of the housing structure 50, the locking device 30 may move downwards, i.e., away from, the housing structure 50. The contact between the latch handle 40 and the locking device 30 may be contestant or intermittent, such as only when the latch handle 40 is being biased.

In use, when the latch handle 40 is biased and moved in the second direction, the locking device may either extend past the upper plane 22 of the mounting shoe receiving structure 20 or retract from the upper plane 22 of the mounting shoe receiving structure 20, as may be determined by design, to either engage or disengage the mounting shoe from the mounting shoe receiving structure 20. The springs 52 or other biasing devices may be used to provide a constant bias on the locking device 30 in a particular direction, commonly either away from the housing structure 50 or towards it. Thus, a user can easily depress the latch handle 40 to retract the locking device 30 and release the mounting shoe from the mounting shoe receiving structure 20.

An end of the locking device 30 with the pivot point 35, the locking device 30 may have a variety of shapes, such as a unitary end or a forked end with any number of protrusions, as depicted. When a forked end is present, as shown, the axle 34 may have four or more points of sheer stress which may provide benefits in lessening the two stress points on an axle 34 without a forked design. The end of the locking device 30 may further include stops 38 positioned to stop a range of movement of the locking device 30. For example, the stops may contact a portion of the housing structure 50 to limit the distance of movement of the locking device 30 past the upper plane 22 of the mounting shoe receiving structure 20.

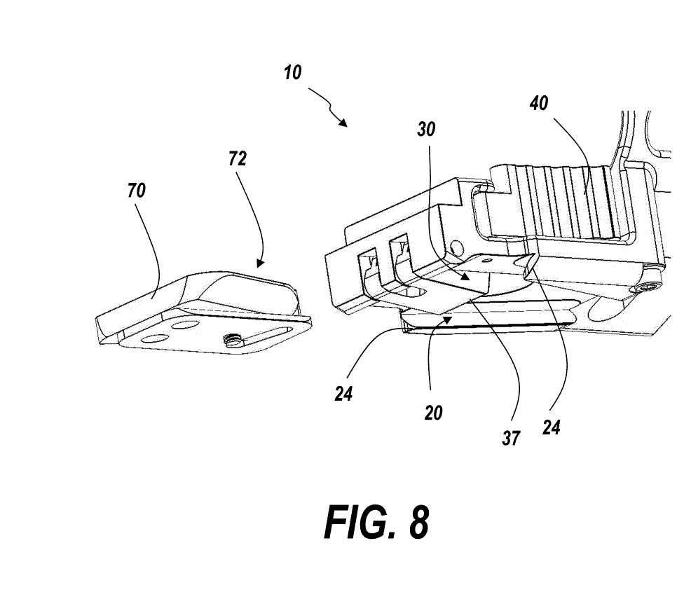

FIGS. 6A-6B are isometric view illustrations of the mounting system latch apparatus 10 of FIG. 1 with the locking device 30 in engaged and disengaged positions, in accordance with the first exemplary embodiment of the present disclosure. Specifically, FIG. 6A illustrates the locking device 30 in the engaged position, with the locking surface 37 positioned below the upper plane 22 of the mounting shoe receiving structure 20, such that it would engage with a cavity of the mounting shoe positioned therein. In the engaged position, the latch handle 40 may be in an uninfluenced state, e.g., with no forces being applied to it. Accordingly, the natural position of the locking device 30 may be the engaged position. When the latch handle 40 is influenced by a user depressing it inwards, towards an interior of the housing structure 50, the engaging structure 42 (FIGS. 2A, 4A-4B) of the latch handle 40 biases the locking device 30 into the disengaged position, as shown in FIG. 6B. As can be seen, in the disengaged position, the locking face 37 of the locking device 30 is retracted from an intersecting position with the plane 22 or upper ceiling of the mounting shoe locking structure 20. In this disengaged position, the mounting shoe can be removed from the mounting shoe locking structure 20.

FIG. 7 is a top partial exploded view illustration of the apparatus 10 of FIG. 1 with a mounting shoe, in accordance with the first exemplary embodiment of the present disclosure. FIG. 8 is a bottom partial exploded view illustration of the apparatus 10 of FIG. 1 with a mounting shoe, in accordance with the first exemplary embodiment of the present disclosure. As is shown in FIGS. 7-8, the mounting shoe 70 may have a mounting cavity 72. When the mounting shoe 70 is positioned within the mounting shoe receiving structure 20, the mounting cavity 72 may substantially align with the locking device 30, such that the locking device 30 is positioned at least partially within the mounting cavity 72. This orientation of the mounting cavity 72 and locking surface 37 of the locking device 30 may prevent the mounting shoe 70 from being removed from the mounting shoe receiving structure 20.

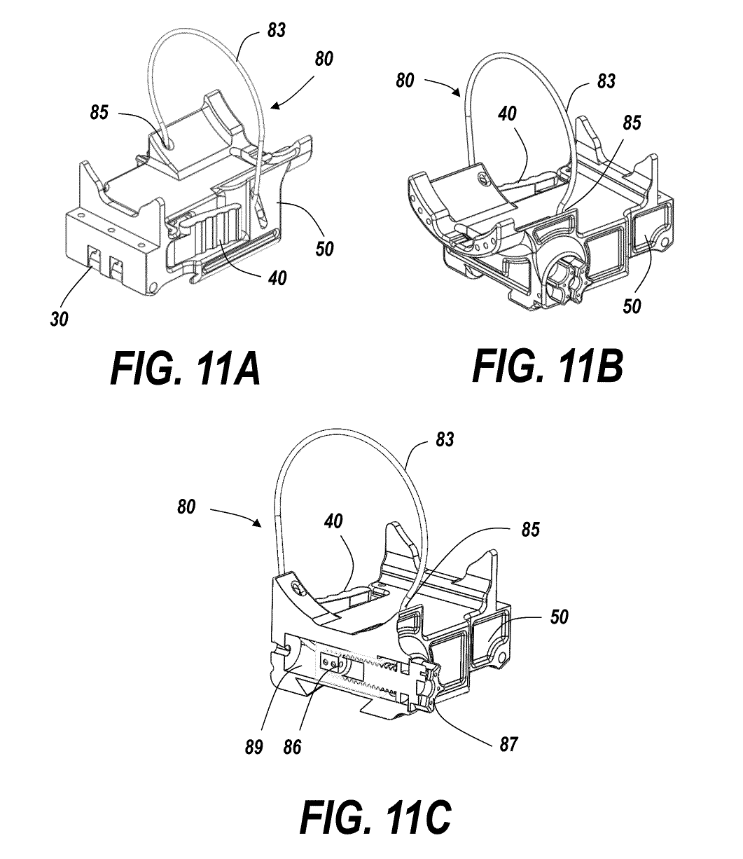

FIGS. 9-10 are isometric illustrations of the mounting system latch apparatus 10 used with an optical device retaining structure 80, in accordance with the first exemplary embodiment of the present disclosure. As is shown in FIGS. 9-10, the housing structure 50 may include an optical device retaining structure 80 which can be used to retain an optical device to the housing structure 50. Accordingly, the apparatus 10 can be used to connect two optical devices: one to the mounting shoe receiving structure 20 positioned on an underside of the housing structure 50, and another to the optical device retaining structure 80 positioned on an upper side of the housing structure 50. In this orientation, the housing structure 50 may be positioned between the optical device retaining structure 80 and the mounting shoe receiving structure 20. Similarly, the locking device 30 and latch handle 40 may be positioned between the mounting shoe receiving structure 20 and the optical device retaining structure 80 and the second direction 44 in which the latch handle 40 is moved may be a directional path positioned between the mounting shoe receiving structure 20 and the optical device retaining structure 80.

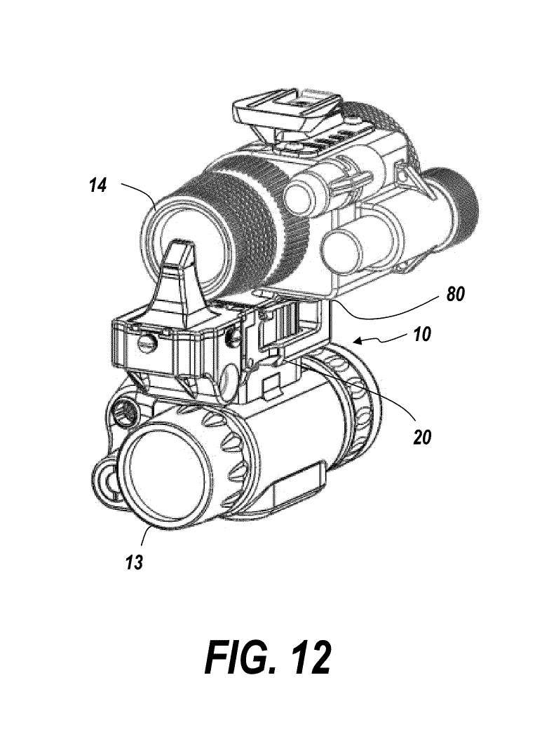

The optical device retaining structure 80 may be used with the cage body 54 of the housing structure 50, as shown in FIG. 9, or without the cage body 54, as shown in FIG. 10. In either situation, the optical device retaining structure 80 may include one or more of a variety of structures to retain the optical device thereto, including a cage body 54 along, a threaded fastener 56, a rigid retaining arm 82, and/or a flexible retaining arm (discussed relative to FIGS. 11A-11C). Cage body 54 may be shaped to engage with the exterior shape of the optical device to hold it within the optical device retaining structure 80, whereas the threaded fastener 56 may thread into a female receiver within the optical device to hold it within the optical device retaining structure 80.

When retaining arm 82 is used as the optical device retaining structure 80, it may be positioned at least partially around the optical device and be capable of being secured in that position. For example, the rigid retaining arm 82 may be a substantially rigid structure which can be fit around the optical device. It may include a pivot joint 84 which the retaining arm 82 pivots on between open and closed positions. An arm locking device 86 may allow clamping of the retaining arm 82 in a closed position. For example, the arm locking device 86 may use a threaded connector 87 which is connected to the end of the retaining arm 82 and draws the retaining arm 82 closed as the threaded connector 87 is rotated. Accordingly, rotation of the threaded connector 87 can act to clamp the retaining arm 82 about the optical device.

FIGS. 11A-11C are two isometric illustrations and one cross-sectional isometric illustration of the mounting system latch apparatus 10 used with an optical device retaining structure 80, in accordance with the first exemplary embodiment of the present disclosure. Similar to the rigid retaining arm 82, FIGS. 11A-11C illustrate a flexible retaining arm 83 which may be positioned at least partially around the optical device and be capable of being secured in that position. For example, the flexible retaining arm 83 may be a substantially flexible material, such as a cord or coated wire which can be fit around the optical device. It may include an attachment joint 85 which connects the retaining arm 83 to the housing structure 50.

An arm locking device 86 may use a threaded connector 87 to secure the retaining arm 83 in a tightened, closed position. For example, the other end of the retaining arm 83 may be positioned within a cavity 89 within the housing structure 50 and be connected to a fastener, such as a barrel nut or similar structure which is constrained within the cavity 89. The arm locking device 86 may allow securing of the retaining arm 83 in a tightened, closed position by drawing the barrel nut within the cavity 89 in a direction towards a threaded connector 87 which can be rotated by the user. Thus, rotation of the threaded connector 87 may cause the length of the retaining arm 83 to shorten, thereby allowing a clamping function around the optical device. Any number of other mechanical fasteners may be used to achieve the connection between the threaded connector 87 and the end of the retaining arm 83.

FIGS. 12-13 are isometric illustrations of the mounting system latch apparatus 10 used with two or more optical devices 13, 14, in accordance with the first exemplary embodiment of the present disclosure. FIG. 12 illustrates the apparatus 10 in use in a monocular arrangement whereas FIG. 13 illustrates the apparatus 10 in use with a binocular arrangement. As is shown, the apparatus 10 can be used to retain optical devices 13, 14 in substantially stationary positions. In one use, one optical device 13 may be a thermal imaging device whereas another optical device 14 may be a night vision imaging device. When the user desires a fused image of the two devices 13, 14, it is critical that the devices 13, 14 are retained in stationary relative positions. To achieve this stationary positioning, one optical device 13 can be affixed to the apparatus 10 using the mounting shoe attachment structure 20, whereas the other optical device 14 can be affixed using the optical device retaining structure 80. The devices 13, 14 may be positioned vertically above/below one another, such that optical axes of the lenses of the devices 13, 14 are substantially coplanar. An image transfer device can be used to combine the images.

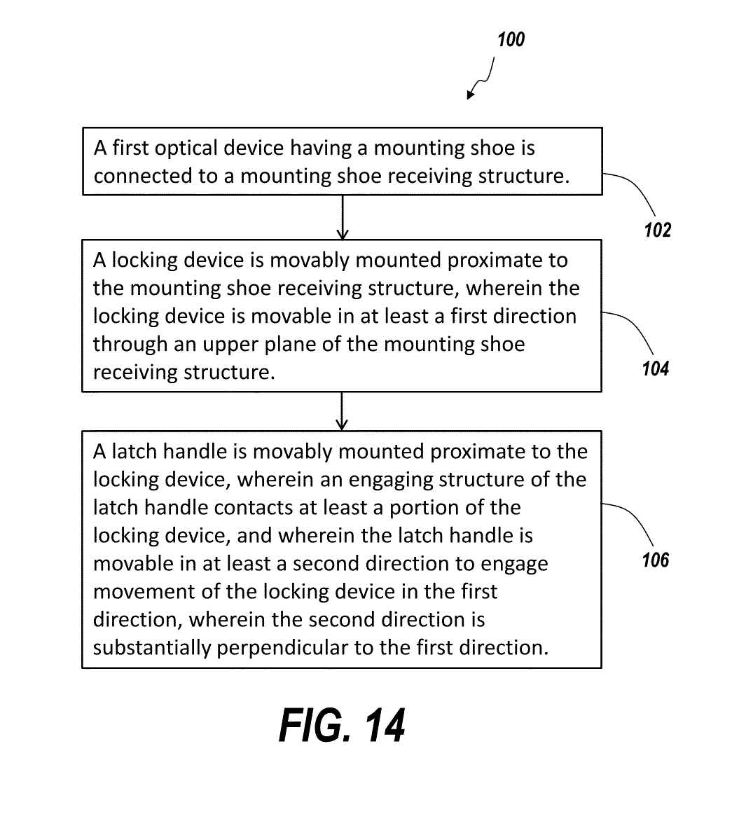

FIG. 14 is a flowchart 100 illustrating a method of using a dual optical device mounting system latch apparatus 10, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a first optical device having a mounting shoe is connected to a mounting shoe receiving structure. A locking device is movably mounted proximate to the mounting shoe receiving structure, wherein the locking device is movable in at least a first direction through an upper plane of the mounting shoe receiving structure (block 104). A latch handle is movably mounted proximate to the locking device, wherein an engaging structure of the latch handle contacts at least a portion of the locking device, and wherein the latch handle is movable in at least a second direction to engage movement of the locking device in the first direction, wherein the second direction is substantially perpendicular to the first direction (block 106).

A number of additional steps, processes, and functions may be included with the method, including any disclosed herein. For example, a second optical device may be mounted to an optical device retaining structure, wherein the locking device and the latch handle are positioned between the first and second optical devices. The mounting shoe of the first optical device may be disconnected from the mounting shoe receiving structure by biasing the latch handle thereby retracting the locking device from the upper plane of the mounting shoe receiving structure. The locking device and latch handle may be movably mounted to a housing structure, wherein the mounting shoe receiving structure is positioned on a bottom of the housing structure and the optical device retaining structure is positioned on a top of the housing structure. The first and second optical devices may be retained in relative static positions. The second optical device may be positioned vertically above the first optical device, whereby optical axes of the first and second optical devices are substantially coplanar.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A mounting system latch apparatus comprising:
a mounting shoe receiving structure;
a locking device movably mounted proximate to the mounting shoe receiving structure, wherein the locking device is movable in at least a first direction through an upper plane of the mounting shoe receiving structure; and
a latch handle movably mounted proximate to the locking device, wherein an engaging structure of the latch handle contacts the locking device, and wherein the latch handle is movable in at least a second direction to engage movement of the locking device in the first direction, wherein the second direction is substantially perpendicular to the first direction.

2. The mounting system latch apparatus of claim 1, wherein the latch handle and the locking device are each pivotally mounted to a housing structure.

3. The mounting system latch apparatus of claim 2, further comprising at least one biasing element positioned between the locking device and the housing structure.

4. The mounting system latch apparatus of claim 2, wherein the housing structure is positioned between a first optical device retaining structure and the mounting shoe receiving structure, wherein a second optical device retaining structure is connectable to the mounting shoe receiving structure.

5. The mounting system latch apparatus of claim 4, wherein the first optical device retaining structure further comprises at least one of:
a cage body;
a threaded fastener;
a rigid retaining arm; and
a flexible retaining arm.

6. The mounting system latch apparatus of claim 1, wherein the locking device is movable between an engaged position and a disengaged position, wherein in the engaged position, the locking device is positioned intersecting the upper plane of the mounting shoe receiving structure, and wherein in the disengaged position, the locking device is not positioned intersecting the upper plane of the mounting shoe receiving structure.

7. The mounting system latch apparatus of claim 1, wherein the mounting shoe receiving structure further comprises two inwardly angled, tapered sidewalls positioned on opposing edges of a ceiling of the mounting shoe receiving structure.

8. The mounting system latch apparatus of claim 1, wherein the latch handle further comprises an elongated body having a pivot point at a first end, wherein the engaging structure is positioned extending laterally from the elongated body.

9. The mounting system latch apparatus of claim 1, wherein the locking device further comprises a locking face and an engaging face, wherein the engaging face is positioned distal from a pivot point.

10. The mounting system latch apparatus of claim 9, wherein the engaging face further comprises a substantially planar surface having a groove formed therein.

11. The mounting system latch apparatus of claim 10, further comprising a contact surface positioned on the engaging face, wherein the contact surface is positioned between the groove and a terminating end of the engaging face.

12. The mounting system latch apparatus of claim 11, wherein the locking face is positioned substantially parallel to the contact surface.

13. A dual optical device mounting system latch comprising:
a housing structure comprising:
a mounting shoe receiving structure sized to receive a mounting shoe of a first optical device therein;
a locking device pivotally mounted to the housing structure, wherein the locking device is movable in at least a first direction through an upper plane of the mounting shoe receiving structure; and
a latch handle pivotally mounted to the housing structure, wherein an engaging structure of the latch handle is positioned in sliding contact with an engaging face of the locking device, and wherein the latch handle is movable in at least a second direction to control movement of the locking device in the first direction, wherein the second direction is substantially perpendicular to the first direction; and
an optical device retaining structure connected to the housing structure, wherein the optical device retaining structure is sized to retain a second optical device therein.

14. The dual optical device mounting system latch of claim 13, wherein the locking device and latch handle are positioned between the mounting shoe receiving structure and the optical device retaining structure.

15. The dual optical device mounting system latch of claim 14, wherein the second direction further comprises a directional path positioned between the mounting shoe receiving structure and the optical device retaining structure.

16. A method of using a dual optical device mounting system latch, the method comprising:
connecting a first optical device having a mounting shoe to a mounting shoe receiving structure;
movably mounting a locking device proximate to the mounting shoe receiving structure, wherein the locking device is movable in at least a first direction through an upper plane of the mounting shoe receiving structure; and
movably mounting a latch handle proximate to the locking device, wherein an engaging structure of the latch handle contacts at least a portion of the locking device, and wherein the latch handle is movable in at least a second direction to engage movement of the locking device in the first direction, wherein the second direction is substantially perpendicular to the first direction.

17. The method of claim 16, further comprising mounting a second optical device to an optical device retaining structure, wherein the locking device and the latch handle are positioned between the first and second optical devices.

18. The method of claim 17, further comprising disconnecting the mounting shoe of the first optical device from the mounting shoe receiving structure by biasing the latch handle thereby retracting the locking device from the upper plane of the mounting shoe receiving structure.

19. The method of claim 17, wherein the locking device and latch handle are movably mounted to a housing structure, wherein the mounting shoe receiving structure is positioned on a bottom of the housing structure and the optical device retaining structure is positioned on a top of the housing structure, further comprising retaining the first and second optical devices in relative static positions.

20. The method of claim 19, further comprising positioning the second optical device vertically above the first optical device, whereby optical axes of the first and second optical devices are substantially coplanar.
